(19) United States
(12) Patent Application Publication
(10) Pub. No.: US 2023/0347876 A1
(43) Pub. Date: Nov. 2, 2023

(54) ADAS TIMING ADJUSTMENTS AND SELECTIVE INCIDENT ALERTS BASED ON RISK FACTOR INFORMATION

(71) Applicant: Rivian IP Holdings, LLC, Irvine, CA (US)

(72) Inventors: Jason Meyer Quint, Ann Arbor, MI (US); Kok Wei Koh, Mountain View, CA (US)

(21) Appl. No.: 17/733,794

(22) Filed: Apr. 29, 2022

(51) Int. Cl. B60W 30/09; B60W 30/14; B60W 50/14

(52) U.S. Cl. CPC B60W 30/09; B60W 30/14; B60W 50/14; B60W 2520/10; B60W 2050/146; B60W 2552/00; B60W 2555/20; B60W 2554/4046; B60W 2556/10; B60W 2540/229; B60W 2540/12; B60W 2540/18; B60W 2530/20; B60W 2510/18; B60W 2540/10

(57) ABSTRACT

Systems and methods are provided for an Advanced Driver Assistance System (ADAS) with adjustable timing thresholds and an incident alert system of a vehicle. An ADAS system is configured to receive risk factor information and sensor data. The system is further configured to adjust a threshold based on the risk factor information, wherein the threshold affects timing of an ADAS feature, and determine whether to perform the ADAS feature based on the adjusted threshold and the sensor data. An incident alert system is configured to receive risk factor information and road hazard information. The system is further configured to determine whether the road hazard information indicates a road hazard is present on a vehicle route and determine whether to present the incident alert or when to present the incident alert based on the risk factor information.

### INTRODUCTION

The present disclosure is directed to Advanced Driving Assistance System (ADAS) and incident alert systems and methods, and more specifically to adjusting the timing of ADAS features and presenting incident alerts based on risk factor information.

### SUMMARY

Advanced Driving Assistance Systems (ADAS) and incident alert systems are generally configured to warn drivers or aid in the avoidance of hazards in order to increase car and road safety. For example, ADAS is used to detect nearby obstacles or driver errors and respond with corresponding warnings or actions. Incident alert systems may retrieve real-time data in order to alert a driver of a vehicle of, for example, a road hazard. However, both ADAS and incident alert systems do not consider other conditions such as driver behavior, environmental conditions, and vehicle status. In accordance with the present disclosure, systems and methods are provided for adjusting the timing of ADAS features and determining whether and when to present incident alerts based on risk factor information. Risk factor information is information that affects a vehicle's ability to react to a surrounding environment and is used, for example, to affect how and when ADAS feature warnings and incident alerts are presented to the driver. ADAS features and incident alerts for vehicles use thresholds (e.g., a distance threshold from a road hazard or a distance threshold from an object in front of the vehicle) that affect the timing of when these features and incident alerts are performed. By these adjusting these thresholds, the sensitivity of the ADAS features and incident alerts are adjusted to consider risk factor information (e.g., a wet road or poor visibility due to fog).

In some embodiments, when an ADAS feature threshold is met, this results in either a warning to the driver or an automatic action to assist in preventing or avoiding hazards. According to the present disclosure, one or more ADAS feature thresholds are adjustable based on risk factor information such as driver behavior information, vehicle state information, and environmental conditions. For example, a first vehicle may be traveling behind a second vehicle downhill and gaining on the second vehicle. The forward collision warning (FCW) ADAS feature has a threshold (e.g., based on vehicle distance and relative vehicle speed) after which the FCW is displayed to the driver of the first vehicle. In this case, because the vehicles are traveling downhill, which generally results in an increased stopping distance, the FCW threshold will be adjusted such that the FCW is presented earlier to provide the driver of the first vehicle with additional time to avoid the second vehicle.

In accordance with some embodiments of the present disclosure, systems and methods are provided for providing an ADAS feature of a vehicle based on an adjustable threshold that affects the timing of when the ADAS feature is performed. In some embodiments, the ADAS system comprises input circuitry configured to receive risk factor information that affects a vehicle's ability to react to a surrounding environment at a vehicle speed and sensor data. The ADAS system may further comprise processing circuitry configured to adjust a threshold based on the risk factor information, where the threshold affects timing of an ADAS feature. The processing circuitry is further configured to determine whether to perform the ADAS feature based on the adjusted threshold and the sensor data. The ADAS feature can be any of a number of ADAS features including, for example, a forward collision warning (FCW) feature, a blind spot warning (BSW) feature, an adaptive cruise control (ACC) feature, or an automatic emergency braking (AEB) feature. In some embodiments, the ADAS feature includes automatic emergency braking, where an automatic brake system is configured to, in response to determining to perform the ADAS feature, activate automatic braking of the vehicle.

In some embodiments, the risk factor information includes environmental conditions, driver behavior information, and/or vehicle state information. The environmental conditions may include, for example, one or more of road geometry, traffic obstructions, road surface condition, weather, tailgating vehicle, or available escape route. The driver behavior information may include, for example, one or more of history of ADAS warnings, average braking reaction time, steering wheel adjustments, driver experience, or driver distraction. The vehicle state information may include, for example, one or more of tire wear, brake wear, accelerator pedal position, vehicle lane, windshield clarity, or vehicle equipment.

In some embodiments, the risk factor information indicates a risk level (e.g., associated with an ADAS feature). When the risk factor information indicates a first risk level, the processing circuitry may be configured to adjust the threshold so that the timing of an associated ADAS feature occurs at a first time and when the risk factor information indicates a second higher risk level, the threshold is adjusted so that the timing of the ADAS feature occurs at a second earlier time. For example, a FCW notification can be displayed earlier when the road is wet than when the road is dry.

In some embodiments, the risk factor information comprises multiple risk factors (e.g., a first risk factor, a second risk factor, etc.). In some embodiments, the processing circuitry is configured to determine a total risk score as a weighted summation of each of the multiple risk factors. The processing circuitry then adjusts the threshold based on the risk factor information by adjusting the threshold based on the total risk score.

In some embodiments, the sensor data is received from one or more of a camera, radar sensor, angle sensor, accelerometer, or a global positioning system. The sensor data can be used, for example, to identify objects (e.g., vehicles) in the environment surrounding the vehicle. The sensor data can be used together with the adjustable threshold to determine whether to perform ADAS features.

In some embodiments, the ADAS system may also include output circuitry that sends a signal to perform the ADAS feature (e.g., to an automatic braking system or to cause a visual notification to be displayed) in response to determining to perform the ADAS feature.

In accordance with some embodiments of the present disclosure, risk factor information is used to determine whether or when to present incident alerts. For example, a first vehicle and a second vehicle may be driving along a three-lane road such that the first vehicle is in the rightmost lane and the second vehicle is in the leftmost lane. When road hazard information is received indicating that a road hazard is approaching in the rightmost lane of the road, an incident alert may or may not be generated based on risk factor information, such as vehicle lane. The first vehicle in this example is in the rightmost lane and the road hazard is also in the right lane. The vehicle lane status of the first vehicle therefore indicates a high risk with respect to the road hazard. Accordingly, an incident alert system of the first vehicle may determine to present an incident alert notifying the driver of the first vehicle of the road hazard. The second vehicle, however, is in the leftmost lane. Because the second vehicle is not in the same lane as the road hazard, the vehicle lane status of the second vehicle indicates a low risk with respect to the road hazard. Accordingly, an incident alert system of the second vehicle may determine to not present an incident alert to the driver of the second vehicle to avoid excessive incident alerts.

In accordance with some embodiments of the present disclosure, systems and methods are provided for providing incident alerts based on risk factor information. In some embodiments, the incident alert system comprises input circuitry configured to receive risk factor information that affects a vehicle's ability to avoid a road hazard and road hazard information. The incident alert system may further comprise processing circuitry configured to determine whether the road hazard information indicates a road hazard is present on a vehicle route and determine whether to present an incident alert or when to present the incident alert based on the risk factor information.

In some embodiments, the risk factor information includes environmental conditions, vehicle state information, and/or driver behavior information, including the examples discussed above in connection with the ADAS system. In some embodiments, the risk factor information indicates a risk level (e.g., associated with a road hazard). In some embodiments, the processing circuitry determines whether or when to present the incident alert by determining a risk level based on one or both of the risk factor information and the road hazard information and then comparing the risk level to a threshold that is used to determine whether to display the incident alert.

In some embodiments, when the risk factor information indicates a first risk level, the processing circuitry is configured to determine when to present the incident alert by determining to present the incident alert at a first time. When the risk factor information indicates a second higher risk level, the processing circuitry is configured to determine when to present the incident alert by determining to present the incident alert at a second earlier time. For example, an incident alert can be presented earlier when a road is curvy than when the road is straight because visibility may be limited when the road is curvy.

In some embodiments, the risk factor information comprises multiple risk factors (e.g., a first risk factor, a second risk factor, etc.). In some embodiments, the processing circuitry is configured to determine a total risk score as a weighted summation of each of the multiple risk factors. The processing circuitry then determines whether to present the incident alert or when to present the incident alert based on the total risk score.

In some embodiments of the present disclosure, the road hazard information includes one or more of a road closure, construction, road hazard, lane restriction, disabled vehicle, or car crash.

In some embodiments the incident alert system comprises a navigation interface configured to display the incident alert to the driver of the vehicle. In some embodiments, the navigation interface displays a navigation map and the incident alert on the navigation map as an incident alert icon that indicates a type of incident alert.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a block diagram of components of a system for providing ADAS features and incident alerts for a vehicle based on risk factor information, in accordance with some embodiments of the present disclosure;

FIG. 2 shows an illustrative depiction of an interior of a vehicle in which ADAS features and incident alert user interfaces may be provided to a driver, in accordance with some embodiments of the present disclosure;

FIG. 3A shows an aerial view of a road and three different adjusted time thresholds for forward collision warning ADAS feature based on different road gradients, in accordance with some embodiments of the present disclosure;

FIG. 3B shows an aerial view of a scenario with two different adjusted threshold distances for blind spot warning ADAS feature based on different visibilities, in accordance with some embodiments of the present disclosure;

FIG. 4 shows a flowchart of an illustrative process 400 for adjusting a threshold for an ADAS feature, in accordance with some embodiments of the present disclosure;

FIG. 5 shows a flowchart of an illustrative process for determining how to adjust the thresholds of an N number of ADAS features, in accordance with some embodiments of the present disclosure;

FIG. 6 shows an aerial view of a road on which there is a road hazard, in accordance with some embodiments of the present disclosure;

FIG. 7 shows illustrative depictions of icons for road and weather incident alerts, in accordance with some embodiments of the present disclosure;

FIG. 8A shows an illustrative navigation interface of a vehicle in free drive navigation and multiple incident alert icons that are selectable by user input, in accordance with some embodiments of the present disclosure;

FIG. 8B shows an illustrative navigation interface of a vehicle in free drive navigation and multiple incident alert icons that are selectable by user input, in accordance with some embodiments of the present disclosure;

FIG. 9A shows an illustrative navigation interface of a vehicle indicator on a guided route and an incident alert icon on the route, where the icon has alerted the driver, in accordance with some embodiments of the present disclosure;

FIG. 9B shows an illustrative navigation interface of a vehicle indicator on a guided route, an incident alert icon on the route, an alternative route that avoids the road hazard, and an alert that provides the driver options to accept or dismiss the alternative route, in accordance with some embodiments of the present disclosure; and

FIG. 10 shows a flowchart of an illustrative process for determining whether to present an incident alert to the driver based on risk factor information, in accordance with some embodiments of the present disclosure.

### DETAILED DESCRIPTION

The present disclosure is directed to an Advanced Driving Assistance System (ADAS) and incident alert systems and associated methods for adjusting the timing of ADAS features and presenting road hazards based on risk factor information. Risk factor information is information that affects a vehicle's ability to react to a surrounding environment at a given vehicle speed or ability to avoid a road hazard. For example, a vehicle traveling at 50 miles an hour will react differently depending on whether the road is flat, inclined, or declined. As another example, the vehicle's ability to react will be different depending on weather conditions (e.g., whether the road is wet or dry and whether visibility is limited due to fog or rain). In some embodiments, risk factor information includes driver behavior information, vehicle state information, and environmental conditions. The systems and methods of the present disclosure provide incident alerts via displays, sounds, or tactile elements that may warn the driver of a hazard based on risk factor information. For example, when the risk factor information indicates that the risk level is low for an upcoming road hazard, the incident alert may either not be displayed or it may be displayed shortly before the presence of the incident alert. The systems and methods of the present disclosure can also adjust the timing of ADAS features (e.g., by adjusting a threshold), which may include one or more of forward collision warning (FCW) features, blind spot warning (BSW) features, adaptive cruise control (ACC) features, or automatic emergency braking (AEB) features. For example, when the risk factor information indicates that the risk level is high (e.g., the road is wet), a FCW may be displayed sooner and the AEB braking may be applied sooner than when the road is dry.

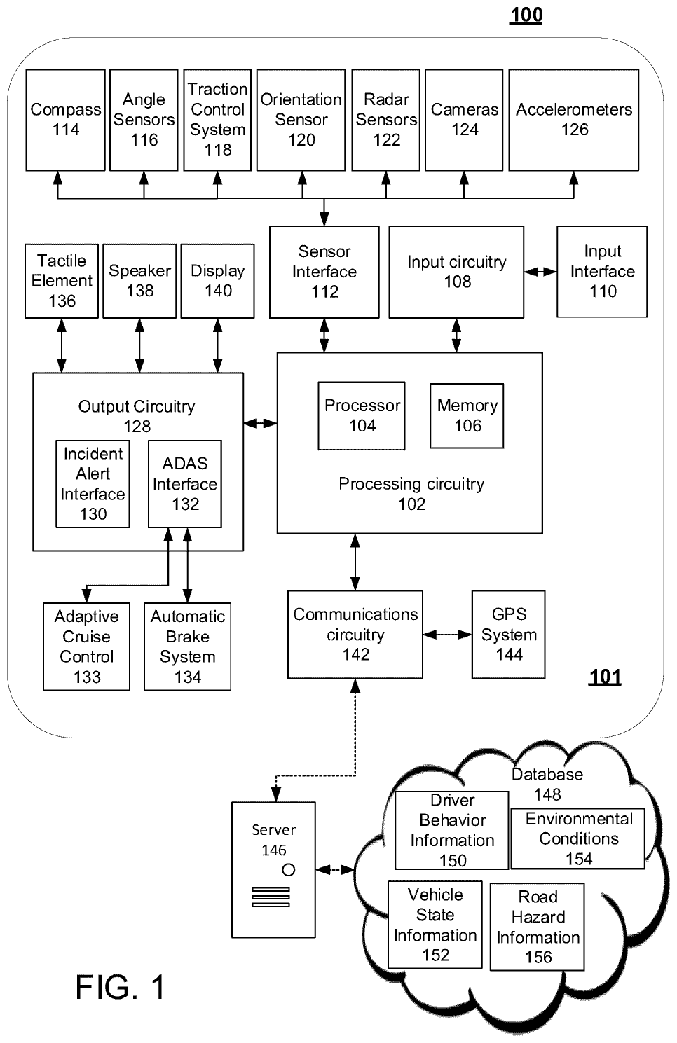

FIG. 1 shows a block diagram of components of a system 100 for providing ADAS features and incident alerts for a vehicle 101 based on risk factor information, in accordance with some embodiments of the present disclosure. In some implementations, the vehicle 101 may be a car (e.g., a coupe, a sedan, a truck, an SUV, a bus), a motorcycle, an aircraft (e.g., a drone), a watercraft (e.g., a boat), or any other type of vehicle. The vehicle may comprise processing circuitry 102, which may comprise a processor 104 and memory 106. Processor 104 may comprise a hardware processor, a software processor (e.g., a processor emulated using a virtual machine), or any combination thereof. In some embodiments, processor 104 and memory 106 in combination may be referred to as processing circuitry 102 of vehicle 101. In some embodiments, processor 104 alone may be referred to as processing circuitry 102 of vehicle 101. Memory 106 may comprise hardware elements for non-transitory storage of commands or instructions, that, when executed by processor 104, cause processor 104 to operate vehicle 101 in accordance with embodiments described above and below. The memory 106 may further store sensor data received via the sensor interface 112 as well as risk factor information received from database 148, including a driver behavior information 150, vehicle state information 152, and environmental conditions 154 (e.g., hyperlocal weather conditions) and road hazard information 156. Processing circuitry 102 may be communicatively connected to components of vehicle 101 via one or more wires, or via wireless connection.

Processing circuitry 102 may be communicatively connected to a sensor interface 112, which may be configured to provide a network bus for a set of sensors used on the vehicle. The set of sensors may include a compass 114, angle sensors 116, a traction control system 118, an orientation sensor 120, a radar sensor 122, cameras 124, or accelerometers 126. In some embodiments, to retrieve the sensor data from the set of sensors, the processing circuitry 102 may continuously poll via the sensor interface 112. In some embodiments, one or more of these sensors are used for an advanced driver assistance system (ADAS). Some ADAS features include forward collision warning (FCW) features, blind spot warning (BSW) features, adaptive cruise control (ACC) 133 features, and automatic emergency braking (AEB) 134 features. For example, radar sensors 122 and accelerometers 126 may be used for determining when to alert drivers of ADAS feature warnings or performing automatic events.

The processing circuitry 102 may also be communicatively connected to output circuitry 128, which is configured to manage an ADAS interface 132 and an incident alert interface 130. Both the ADAS interface 132 and the incident alert interface 130, by way of the output circuitry 128, may be communicatively connected to a tactile element 136, speaker 138, and display 140 for user-facing tactile, audible, or visual ADAS feature alerts or incident alerts, respectively. Display 140 may be located at a dashboard of vehicle 101 and/or a heads-up display at a windshield of vehicle 101. For example, display 140 may comprise an LCD display, an OLED display, an LED display, or any other type of display. In some embodiments, the incident alert interface 130 is the network bus interface that manages incident alert signals from the processing circuitry 102 to the output circuitry 128, directing the incident alerts to at least one of the tactile element 136, speaker 138, or the display 140. In some embodiments, the ADAS interface 132 may also be communicatively connected to an automatic brake system 134 that can perform automatic emergency braking based on sensor data and an adjustable AEB threshold. For example, when the processing circuitry 102 determines that the AEB threshold is met, a signal may be sent to the output circuitry 132, which then directs the signal to the automatic brake system 134 via the ADAS interface 132 to execute the AEB feature. In this example, the output circuitry 128 may also send signals to any of the tactile element 136, the speaker 138, or display 140 to alert the driver of the ADAS feature.

An input interface 110 (e.g., a steering wheel, a touch screen display, buttons, knobs, a microphone, or other audio capture device, etc.) may be commutatively coupled to the processing circuitry 102 via input circuitry 108. In some embodiments, a driver of vehicle 101 may be permitted to select certain settings in connection with the operation of vehicle 101 (e.g., accept or dismiss incident alert suggestions). In some embodiments, processing circuitry 102 may be communicatively connected to a navigation system, e.g., Global Positioning System (GPS) system 144 via communications circuitry 142 of vehicle 101, where the driver may interact with the GPS system 144 via input interface 110. GPS system 144 may be in communication with multiple satellites to ascertain the vehicle's location and provide the current vehicle location to the processing circuitry 102. As another example, the positioning device may operate on terrestrial signals, such as cell phone signals, Wi-Fi signals, or ultra-wideband signals to determine a location of electric vehicle 101. The current vehicle location may be in any suitable form such as a geographic coordinate. In some embodiments, processing circuitry 102 uses the current vehicle location to receive road hazard information 156 and environmental conditions 154 within a vicinity of the current vehicle 101 location. In some embodiments, the incident alerts 156 and the environmental conditions 154 may be received from a database 148 via a server 146 that may be communicatively reachable by way of the communications circuitry 142.

In some embodiments, processing circuitry 102 may be in communication (e.g., via communications circuitry 142) with a database 148 (e.g., driver behavior information 150, vehicle state information 152, road hazard information 156, and environmental conditions 154) wirelessly through a server 146. In some embodiments, the driver behavior information 150 may be created by user-inputted information, insurance information, or data from the on-vehicle sensors from the processing circuitry 102 via the communications circuitry 142. In some embodiments, some or all of the information in database 148 may also be stored locally in memory 106 of vehicle 101.

It should be appreciated that FIG. 1 only shows some of the components of vehicle 101, and it will be understood that vehicle 101 also includes other elements commonly found in vehicles, e.g., a motor, brakes, wheels, wheel controls, turn signals, windows, doors, etc.

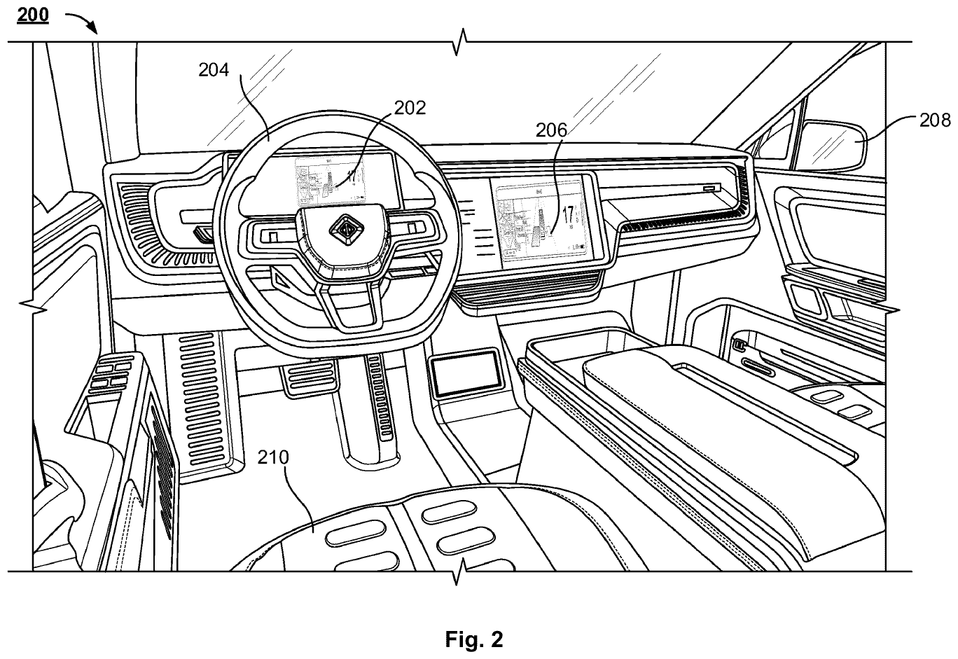

FIG. 2 shows an illustrative depiction of an interior of a vehicle 200 in which ADAS features and incident alert user interfaces may be provided to a driver, in accordance with some embodiments of the present disclosure. A vehicle interior or vehicle cabin 200 may comprise steering wheel 204, one or more displays 202 and/or 206, and driver seat 210. In some embodiments, the interior of a vehicle 200 may be the interior of vehicle 101 in FIG. 1. The vehicle may further include a right side-view mirror 208, a left side-view mirror (not shown) and a rear-view mirror (not shown). Processing circuitry 102 may be configured to generate for output an incident alert, ADAS feature alert, or automatic event to a driver of the vehicle. In some embodiments, processing circuitry 102 may generate for display the incident alert, ADAS feature alert, or automatic event on one or more of the driver display 202 and/or the center display 206 of vehicle 200.

Additionally or alternatively, process circuitry 102 may be configured to generate for output audio indicators or alerts (e.g., to audibly draw the driver's attention to the incident alert or ADAS features) and/or other visual cues (e.g., conspicuous lighting patterns, such as flashing lights, in an effort to gain the driver's attention, such as at light sources located at one or more of steering wheel 204, driver display 202, center display 206, a left side-view mirror, right side-view mirror 208, the rear-view mirror, cabin light, door light, etc.). The audio alerts may be in the form of speech-based instructions and/or an alarm-type indicators (e.g., repetitive, high-pitched chimes intended to urgently capture the driver's attention) transmitted from speakers. In some embodiments, processing circuitry 102 may generate for output tactile or haptic indicators (e.g., to provide tactile or haptic feedback to a driver, e.g., on driver's seat 210, a passenger seat, steering wheel 204, brake pedals, and/or gas pedals). The tactile or haptic feedback may be provided at a position of vehicle 200 intended to indicate to the driver the type of incident alert or ADAS feature. In some embodiments, the tactile elements, the speakers, and the displays 202, 206 may correspond to the tactile elements 136, speakers 138, and display 140 of vehicle 101.

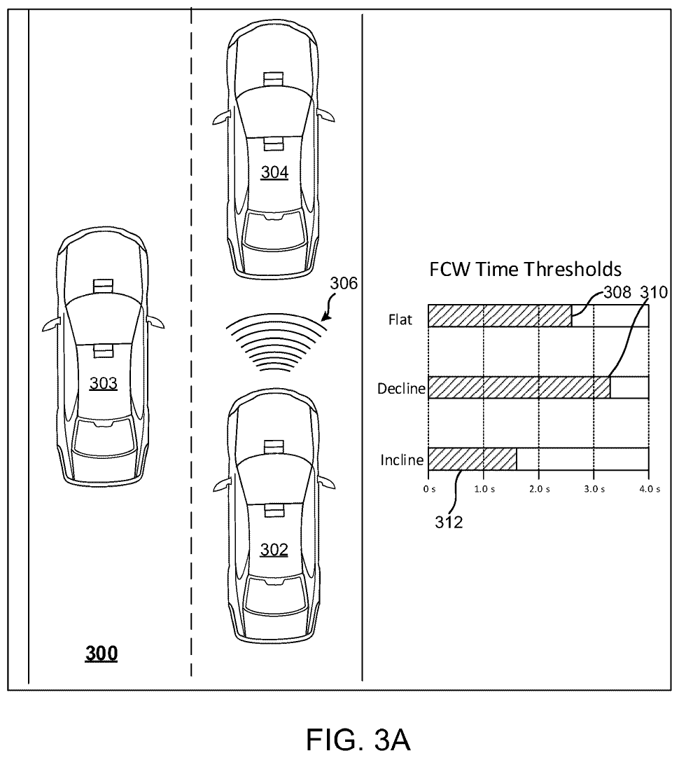

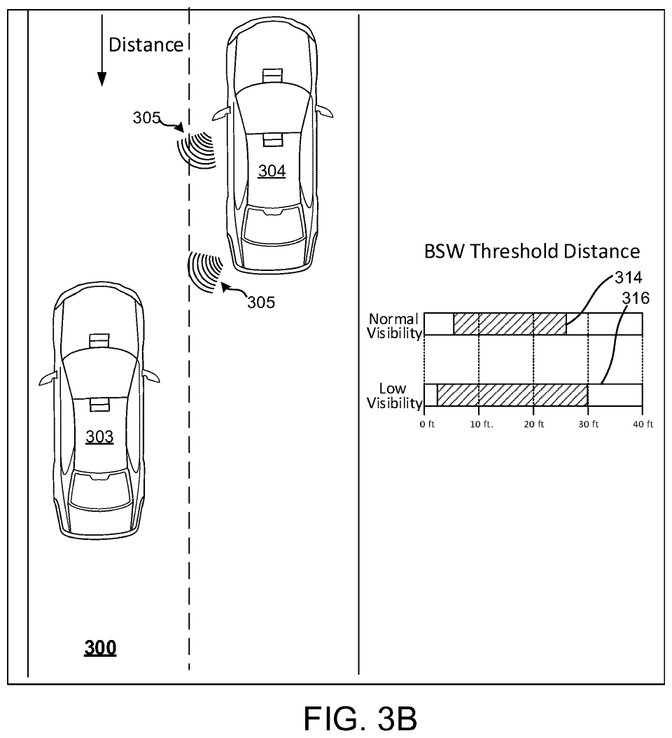

FIG. 3A shows an aerial view 300 of a road and three different adjusted thresholds, in accordance with some embodiments of the present disclosure. View 300 shows three vehicles traveling down a road, with vehicle 302 traveling behind vehicle 304. As vehicle 302 approaches the rear of vehicle 304, radar sensor 306 may detect the presence of vehicle 304 as well as the distance of vehicle 304. As the measured distance decreases, vehicle 302 may display a forward collision warning to the driver of vehicle 302. As explained above, the timing of when an ADAS feature, such as a forward collision warning, is displayed can be adjusted based on risk factor information (e.g., an environmental condition). As illustrated, the timing of when the forward collision warning is displayed is adjusted between three timing thresholds (i.e., 308, 310, 312) based on road gradient, which is an example of an environmental condition. The road gradient can be determined using any suitable technique. For example, the road gradient can be determined using orientation sensor 120 or GPS system 144 along with map information that indicates road gradient. The gradient of the road affects the braking ability of vehicle 302. For example, a vehicle traveling on an incline can stop faster than a vehicle traveling on a decline. Accordingly, vehicle 302 traveling on a decline has a greater risk of colliding with vehicle 304 than while traveling on an incline. Thus, the road gradient indicates relative risk of a forward collision and the timing threshold of when the forward collision warning is displayed is adjusted accordingly. As shown, the timing threshold on a flat road gradient 308 is less than the timing threshold on a decline road gradient 310, which causes the forward collision warning to be displayed earlier when the vehicle 302 is traveling downhill. When the vehicle is on an incline road gradient 312, the timing threshold is less than the timing threshold on a flat road gradient 308, which cause the forward collision warning to be displayed later when the vehicle 302 is travelling uphill. In some embodiments, the timing thresholds in FIG. 3A refer to the amount of time before vehicle 302 will make contact with vehicle 304. It is understood that the adjustable thresholds of the present disclosure can refer to any thresholds that affect the timing of ADAS features or incident alerts.

FIG. 3A is an illustrative example of adjusting the timing of a FCW ADAS feature. However, it will be understood that the timing of any ADAS features can be adjusted based on any risk factor or combination of risk factors. In some embodiments, the ADAS features that can be adjusted include forward collision warning (FCW) features, blind spot warning (BSW) features, adaptive cruise control (ACC) features, or automatic emergency braking (AEB) features. In some embodiments, forward collision warning detects a vehicle or other objects ahead of the vehicle and performs an alert such that the driver may avoid the vehicle or other objects. The threshold of the forward collision warning feature may be associated with the distance to the vehicle or other object before alerting the driver and adjusting the threshold will affect the timing of when the alert is presented. In some embodiments, the blind spot warning detects a second vehicle behind and in an adjacent lane within a blind spot for the driver in a first vehicle. The threshold of the blind spot warning features may be associated with the distance from the first vehicle to the second vehicle before alerting the driver. For example, in poor visibility the threshold may be increased such that a blind spot warning notification will be turned on sooner for a vehicle that is approaching from the rear in an adjacent lane. In some embodiments, adaptive cruise control features control the distance between a first vehicle and a second vehicle ahead of the first vehicle. The threshold of adaptive cruise control may correspond to a distance between the first vehicle and the second vehicle. For example, when the road is wet, the threshold can be increased so that a first vehicle gaining on a second vehicle in front of the first vehicle will be slowed down sooner than when the road is dry. In some embodiments, the automatic emergency brake features control the automatic emergency brake system of the vehicle when it is determined to stop the vehicle to avoid an obstacle. The threshold of the automatic emergency brake may be associated with the distance between the vehicle and another vehicle or object ahead of the vehicle before braking is applied to the vehicle. In each of these cases, a greater threshold corresponds to a greater distance, which in turn affects the timing of the corresponding ADAS feature. For example, if the automatic emergency brake threshold increases, the automatic emergency brake will activate at a greater distance to the object and thus at an earlier time. Conversely, if the automatic emergency brake threshold decreases, the automatic emergency brake may stop the vehicle at a closer distance to the object and thus at a later relative time.

The risk factor information that may be used to adjust the timing thresholds of the ADAS features may include driver behavior information 150, vehicle state information 152, and environmental conditions 154. In some embodiments, the driver behavior information 150 may include one or more of history of ADAS warnings, average braking reaction time, steering wheel adjustments, driver experience, or driver distraction. Steering wheel adjustments may refer to the driver's need to correct the direction of the vehicle to remain with a lane while driving, wherein a driver with many steering wheel adjustments may not retain consistent control of the vehicle. In some embodiments, the vehicle state information 152 may include one or more of tire wear, brake wear, accelerator pedal position, vehicle lane, windshield clarity or vehicle equipment. In some embodiments, the environmental conditions may include one or more of road geometry, traffic obstructions, road surface condition, weather (e.g., hyperlocal weather conditions), tailgating vehicle, or available escape route. Each of these types of risk factor information may cause a timing threshold adjustment. For example, when a vehicle is traveling on an icy or slippery road, the thresholds for adaptive cruise control features, automatic emergency brake features, and forward collision warning features may increase in order to take into account the increased braking risk associated with icy or slippery roads. However, in this scenario, the threshold distance for blind spot warning may not be adjusted for icy or slippery roads.

FIG. 3B shows an aerial view 300 of a scenario with two different adjusted threshold distances for a blind spot warning ADAS feature based on different road visibilities, in accordance with some embodiments of the present disclosure. View 300 shows two vehicles traveling down a road, with vehicle 303 traveling behind and adjacent to vehicle 304. As vehicle 303 approaches vehicle 304, radar sensors 305 may detect the presence of vehicle 303 as well as the distance to vehicle 303 (e.g., the distance from the front of vehicle 304 to the front of vehicle 303 as shown). As the measured distance decreases, vehicle 304 may display a blind spot warning to the driver of vehicle 304. As explained above, the timing of when an ADAS feature, such as a blind spot warning, is displayed can be adjusted based on risk factor information (e.g., an environmental condition). As illustrated, the timing of when the blind spot warning is displayed is adjusted between two threshold distances (i.e., 314, 316) based on visibility, which may be an environmental condition (e.g., low visibility due to fog). Road visibility can be determined using any suitable technique. For example, the road visibility can be determined by receiving hyperlocal weather conditions and using GPS system 144 along with map information that indicates road visibility. The visibility of the road affects the ability of the driver of vehicle 304 of seeing the presence of vehicle 303 when vehicle 303 is in or close to vehicle 304's blind spot. For example, the driver in vehicle 304 traveling on a road with normal visibility may see and avoid vehicle 303 when it is near a blind spot, but that driver may not see vehicle 303 when visibility is impaired. Accordingly, vehicle 304 traveling on a road with low visibility has a greater risk of not seeing and colliding with vehicle 303 than while traveling on a road with normal visibility. Thus, the road visibility indicates relative risk of a blind spot and the timing of when the blind spot warning is displayed is adjusted accordingly. As shown, the threshold distance 314 for displaying a blind spot warning on a road with normal visibility 314 is 5-25 feet, wherein the threshold distance 316 for displaying a blind spot warning on a road with low visibility is 2-30 feet. This means that if vehicle 303 is overtaking vehicle 304, the blind spot warning will be displayed sooner (i.e., at 30 feet away as opposed to 25 feet away) and stay on longer (i.e., until vehicle 303 is 2 feet away as opposed 5 feet away) when there is low visibility.

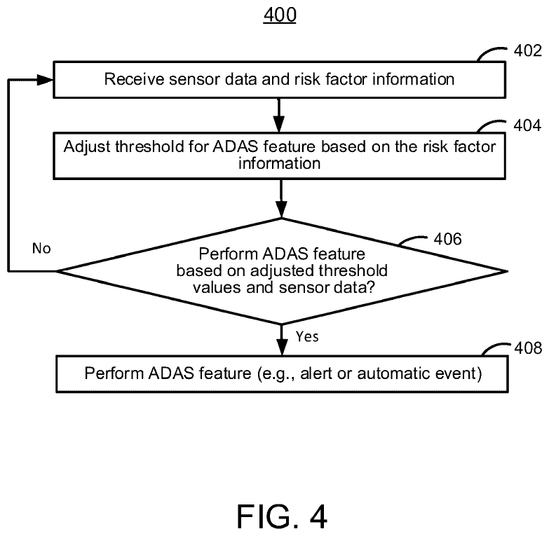

FIG. 4 shows a flowchart of an illustrative process 400 for adjusting a threshold for an ADAS feature, in accordance with some embodiments of the present disclosure. In some embodiments, process 400 is executed by processing circuitry 102 of the vehicle 101. In some embodiments, process 400 is executed by processing circuitry 102 as part of an ADAS system in vehicle 101.

At 402, processing circuitry 102 receives sensor data and risk factor information. In some embodiments, the sensor data is received from one or more of sensors 114, 116, 118, 120, 122, 124, 126 via the sensor interface 112. In some embodiments, the risk factor information is received via the communications circuitry 142 that is communicatively reachable by server 146. In some embodiments, the risk factor information is locally stored and received from memory 106. The risk factor information may include one or more of driver behavior information 150, vehicle state information 152, environmental conditions 154, or any other information that affects a vehicle's ability to react to an environment at a vehicle speed. In some embodiments, the driver behavior information 150 may include one or more of history of ADAS warnings, average braking reaction time, steering wheel adjustments, driver experience, or driver distraction. In some embodiments, the vehicle state information 152 may include one or more of tire wear, brake wear, accelerator pedal depressed, vehicle lane, windshield clarity, or vehicle equipment. In some embodiments, environmental conditions 154 may include one or more of road geometry, traffic obstructions, road surface condition, weather, tailgating vehicle, or available escape route.

At 404, the processing circuitry 102 adjusts the threshold for an ADAS feature based on the received risk factor information. In some embodiments, adjusting the threshold based on the risk factor information includes selecting the threshold based on a risk factor. For example, the threshold for blind spot monitoring can be adjusted by selecting threshold distance 316 when the risk factor information indicates low visibility. In some embodiments, adjusting the threshold includes inputting a risk factor value into an equation or a lookup table to obtain the adjusted threshold. For example, the road gradient can be inputted into an equation (e.g., a linear equation) or a lookup table to obtain an adjusted threshold for a FCW feature. In some embodiments, the processing circuitry 102 may adjust the threshold by determining a total risk score as a weighted summation of a set of risk factors from the risk factor information. In some embodiments, the total risk score (TRS) can be calculated using the following equation:

TRS=(Risk Factor₁)*(Weight₁)+(Risk Factor₂)*(Weight₂)+ . . . +(Risk Factorₙ)*(Weightₙ),

where the total risk score is the weighted summation of n number of risk factors with n number of corresponding weights. In some embodiments, the risk factors are equally weighted. In some embodiments, the risk factors are dynamically weighted based on the importance of the risk factor and/or the type of ADAS feature. The weights may be determined and assigned by the processing circuitry 102 or retrieved by the use of a lookup table.

At 406, the processing circuitry 102 determines whether to perform an ADAS feature based on the adjusted threshold and the received sensor data. In some embodiments, the received sensor data is used by processing circuitry 102 to identify objects surrounding vehicle 101, their relative distances, and their relative speeds. For example, the sensor data (e.g., sensor data from radar sensors 122) may identify a vehicle approaching from the rear in an adjacent lane. As another example, the sensor data may identify a vehicle that vehicle 101 is approaching from the rear. The presence, distance, and/or relative speeds of surrounding objects may be used by processing circuitry 102, along with the adjusted threshold, to determine when to perform the ADAS features associated with the adjusted threshold. For example, if the sensor data indicates that vehicle 101 is approaching an object and the adjusted FCW time threshold is met, then the processing circuitry 102 may determine to perform the ADAS feature. When the processing circuitry 102 determines that the ADAS feature should be performed, process 400 proceeds to step 408. When the processing circuitry 102 determines not to perform the ADAS feature, process 400 proceeds to step 402 to continue receiving sensor data and risk factor information.

At 408, the processing circuitry 102 performs the ADAS feature. In some embodiments, the ADAS feature is an alert such as a forward collision warning (FCW) or blind spot warning (BSW). The processing circuitry 102 may provide the alert to the driver using audio, visual, or tactile elements. For example, a visual FCW alert may be displayed on display 202 or 206. As another example, a BSW alert may be performed by turning on a visible indicator (e.g., a light source) on the left side-view mirror. In some embodiments, the ADAS feature is an automatic event such as adaptive cruise control braking or acceleration or automatic emergency braking (AEB). For example, the processing circuitry 102 may perform automatic emergency braking by sending a signal to automatic brake system 134 to decelerate vehicle 101.

It will be understood that process 400 of FIG. 4 is merely illustrative and that various modifications can be implemented in accordance with the present disclosure.

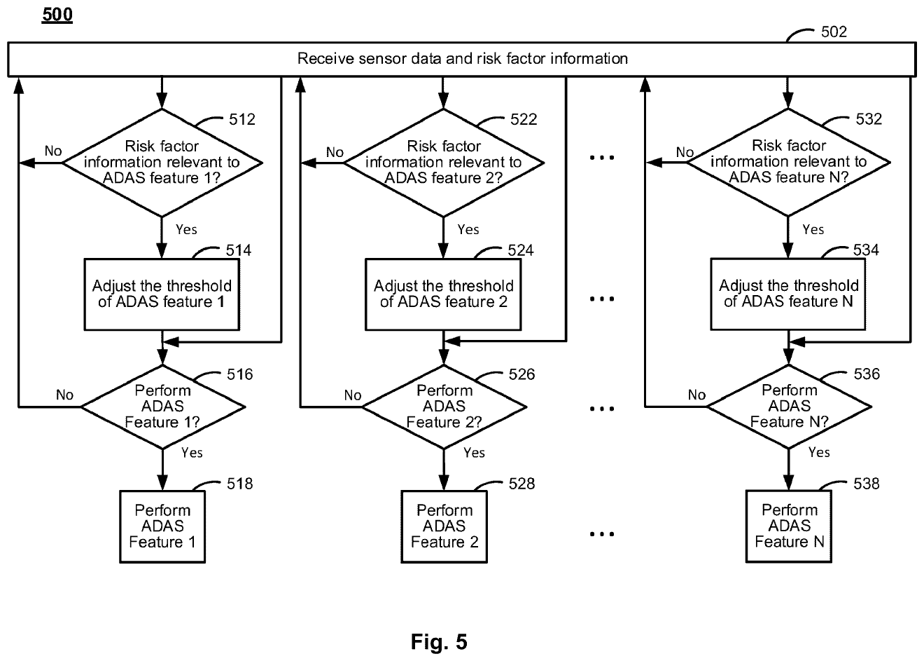

FIG. 5 shows a flowchart 500 of an illustrative process for determining how to adjust the thresholds of an N number of ADAS features, in accordance with some embodiments of the present disclosure. In some embodiments, process 500 is executed by processing circuitry 102 of the vehicle 101. In some embodiments, process 500 is executed by processing circuitry 102 as part of an ADAS system in vehicle 101.

At 502, processing circuitry 102 receives sensor data and risk factor information. In some embodiments, step 502 corresponds to step 402 of FIG. 4. For example, the sensor data can be received from one or more of sensors 114, 116, 118, 120, 122, 124, 126 via the sensor interface 112. In some embodiments, the risk factor information is received via the communications circuitry 142, that is communicatively reachable by server 146, or locally from memory 106. The risk factor information may include one or more of driver behavior information 150, vehicle state information 152, environmental conditions 154, or any other information that affects a vehicle's ability to react to an environment at a vehicle speed. In some embodiments, the risk factor information includes multiple risk factors, where different risk factors affect different ADAS features. For example, as will be explained in more detail below, road gradient and a foggy condition are risk factors that are relevant to different ADAS features. After 502, process 500 proceeds to 512, 522, and 532 in parallel. For example, 512, 522, and 532 may be performed simultaneously or substantially simultaneously.

At 512, 522, 532, processing circuitry 102 determines whether the risk factor information received is relevant to each of the ADAS features (e.g., ADAS feature 1, ADAS feature 2, . . . , ADAS feature N). In some embodiments, a lookup table is used to determine whether risk factor information is relevant to an ADAS feature. For example, when a new or updated risk factor is received, the risk factor can be inputted into a lookup table to identify relevant ADAS features. As an illustrative example, ADAS feature 1 may correspond to a blind spot warning feature, ADAS feature 2 may correspond to a forward collision warning feature, and ADAS feature N may correspond to automatic emergency braking. In this example, the received risk factor information may include, as described above, road gradient and a fog condition. In some embodiments, each of these risk factors is relevant to some, but not all ADAS features. For example, the road gradient affects stopping distance so it is determined to be relevant to the forward collision warning feature and the automatic emergency braking feature, but it may not be relevant to the blind spot warning feature. As another example, the foggy condition affects the ability of a driver to see surrounding objects, so it is determined to be relevant to the forward collision warning feature and the blind spot monitoring features. However, the radar sensors 122 of vehicle 101 may not be affected by the foggy condition. Therefore, the foggy condition may be not be relevant to the automatic emergency braking feature. When the processing circuitry 102 determines that risk factor information received is not relevant to an ADAS feature, the processing circuitry 102 will continue to receive sensor data and risk factor information for that ADAS feature at 502. When the processing circuitry 102 determines that the risk factor information is relevant to one or more of ADAS features 1-N, process 500 proceeds to the corresponding one or more of steps 514, 524, 534.

At 514, 524, 534, the processing circuitry 102 adjusts the threshold for each of the ADAS features based on the received risk factor information. In some embodiments, each of steps 514, 524, and 534 corresponds to step 404 of FIG. 4. In some embodiments, adjusting an ADAS feature threshold based on the risk factor information includes selecting the threshold based on a risk factor. For example, the thresholds for forward collision warning and blind spot warning can be adjusted by selecting a threshold time or threshold distance when the risk factor information is relevant to each of these ADAS features. In some embodiments, adjusting the thresholds include inputting a risk factor value into an equation or a lookup table to obtain the adjusted thresholds. For example, the road gradient or a visibility score can be inputted into an equation (e.g., a linear equation) or a lookup table to obtain an adjusted threshold for the forward collision warning feature and the blind spot warning feature. In the example used above, when the risk factor is road gradient and the gradient decreases, the thresholds for the forward collision warning feature and the automatic emergency braking feature may be adjusted so that the timing of these features occur earlier to provide more time for the driver and vehicle 101 to react, but the threshold for the blind spot warning may remain the same. In addition, when the risk factor is a foggy condition, the thresholds for the blind spot warning feature and the forward collision warning may be adjusted so that timing of these features occur earlier to compensate for the reduced visibility, but the threshold for automatic emergency braking may remain the same.

At 516, 526, 536, the processing circuitry 102 determines whether to perform each ADAS feature based on a threshold and the received sensor data. Steps 516, 526, 536 may be performed after a threshold has been adjusted and when new sensor data is received. In some embodiments, each of steps 516, 526, and 536 corresponds to step 406 of FIG. 4. For example, the processing circuitry 102 may use the sensor data to determine the presence, distance, and/or relative speeds of surrounding objects and use this information together with the appropriate thresholds to determine whether to perform ADAS features 1-N. When the processing circuitry 102 determines that an ADAS feature should not be performed, process 500 continues to receive further sensor data and risk factor information at 502. However, when the processing circuitry 102 determines that one or more ADAS features should be performed, process 500 proceeds to the corresponding one or more of steps 518, 528, 538. For example, if the sensor data (e.g., sensor data from radar sensors 122) identifies a vehicle approaching from the rear in an adjacent lane that meets the blind spot warning distance threshold, processing circuitry 102 determines to perform the blind spot warning ADAS feature.

At 518, 528, 538, the processing circuitry 102 performs respective ADAS features. In some embodiments, each of steps 518, 528, and 538 corresponds to step 408 of FIG. 4. When the ADAS feature is an alert such as a forward collision warning (FCW) or blind spot warning (BSW), the processing circuitry 102 may provide the alert to the driver on at least one of a display, a speaker, or a tactile element via the ADAS interface 132 of the output circuitry 128. For example, a visual FCW alert may be displayed on display 202 or 206. As another example, a BSW alert may be performed by turning on a visible indicator (e.g., a light source) on the right side-view mirror 208. When the ADAS feature is an automatic event such as adaptive cruise control braking or acceleration or automatic emergency braking (AEB), the processing circuitry 102 may generate a signal to cause the event to occur. For example, the processing circuitry 102 may perform automatic emergency braking by sending a signal to the automatic emergency braking system 134, via the ADAS interface 132 of the output circuitry 128, to decelerate the vehicle 101.

It will be understood that process 500 of FIG. 5 is merely illustrative and that various modifications can be implemented in accordance with the present disclosure. For example, while process 500 is shown and described as having multiple parallel paths, it will be understood that the paths can be performed sequentially (e.g., steps 522-528 can perform after steps 512-518).

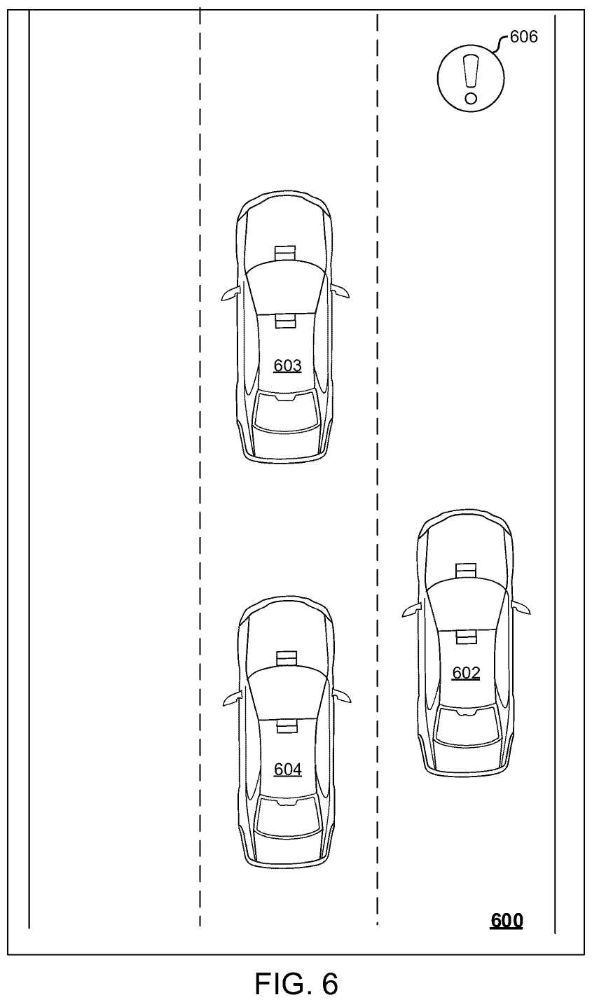

FIG. 6 shows an aerial view 600 of a road in which there is a road hazard, in accordance with some embodiments of the present disclosure. View 600 shows three vehicles traveling down a road, with vehicle 602 in the rightmost lane and vehicles 603 and 604 in the middle lane. Also shown is road hazard 606, which is located farther up in the rightmost lane of the road. In some embodiments, the incident alert system of both vehicles 602, 603 may receive risk factor information and road hazard information. The road hazard information may include a type of road hazard, and a geographical location associated with the road hazard (e.g., the location of road hazard 606). When vehicle 602 in the rightmost lane receives the road hazard information, the incident alert system of vehicle 602 may determine that the vehicle is in the right-most lane (e.g., risk factor information) based on received lane position sensor data, which is an example of vehicle state information 154. The lane position of a vehicle can be determined using any suitable technique. For example, the lane position can be determined using a GPS system 144 with map information that indicates the number of lanes or a front-facing camera 124 along with lane recognition (e.g., using a computer vision algorithm). The lane positioning of a vehicle on a road may affect the ability of the vehicle to avoid a road hazard. For example, vehicle 603 in the middle lane can easily avoid the road hazard 606 because it is in a different lane and thus vehicle 603 will avoid road hazard 606 without needing to take any action. However, vehicle 602 is in the rightmost lane, which is the same lane as the road hazard. Accordingly, vehicle 602 has greater difficulty avoiding road hazard 606 than vehicle 604 in the middle lane. In some embodiments, the incident alert system of vehicle 602 determines to present an incident alert for road hazard 606 to the driver of vehicle 602 based on the lane position indicating that vehicle 602 is in the rightmost lane. However, the incident alert system of vehicle 603 may determine to not present an incident alert for road hazard 606 based on the lane position indicating that vehicle 603 is in the middle lane.

In another example, although vehicle 604 is also in the middle lane, the view from vehicle 604 may be partially obstructed by vehicle 603. In some embodiments, limited visibility is risk factor information, which can be used in combination with the lane position of vehicle 604 by the processing circuitry 102 to determine whether to present and when to present an incident alert. For example, while vehicle 603 with good visibility may not display an incident alert for road hazard 606 because it is in a different lane, vehicle 604 may determine to display an incident because of the low visibility.

In the preceding example, the incident alert may be displayed in vehicle 604 because the driver of vehicle 604 may decide to change lanes and turn into road hazard 606 because their view is partially obstructed due to vehicle 603. Accordingly, in some embodiments, an incident alert system, such as the one in vehicle 604, may determine a total risk score as a weighted summation of a set of risk factors from the risk factor information to provide a more useful incident alert. In this example, the total risk score for vehicle 603, with good visibility, will be less than the total risk score for vehicle 604, with low visibility. By deciding whether or when to display an incident alert based on a total risk score, vehicle 604 is provided with a meaningful incident alert and vehicle 603 is not subjected to an unnecessary incident alert.

The risk factor information that may be used to determine whether an incident alert for a road hazard should be presented to the driver of the vehicle may include driver behavior information 150, vehicle state information 152, environmental conditions 154, as well as other information that affects the vehicle's ability to avoid a road hazard. In some embodiments, the driver behavior may include one or more of average braking reaction time, steering wheel adjustments, driver experience, or driver distraction. Steering wheel adjustments may refer to the driver's need to correct the direction of the vehicle to remain with a lane while driving, wherein a driver with many steering wheel adjustments may not retain consistent control of the vehicle. In some embodiments, the vehicle state may include one or more of tire wear, brake wear, accelerator pedal position, vehicle lane, windshield clarity or vehicle equipment. In some embodiments, the environmental conditions may include one or more of road geometry, tailgating vehicle, traffic obstructions, road surface condition, weather (e.g., hyperlocal weather conditions), or available escape route.

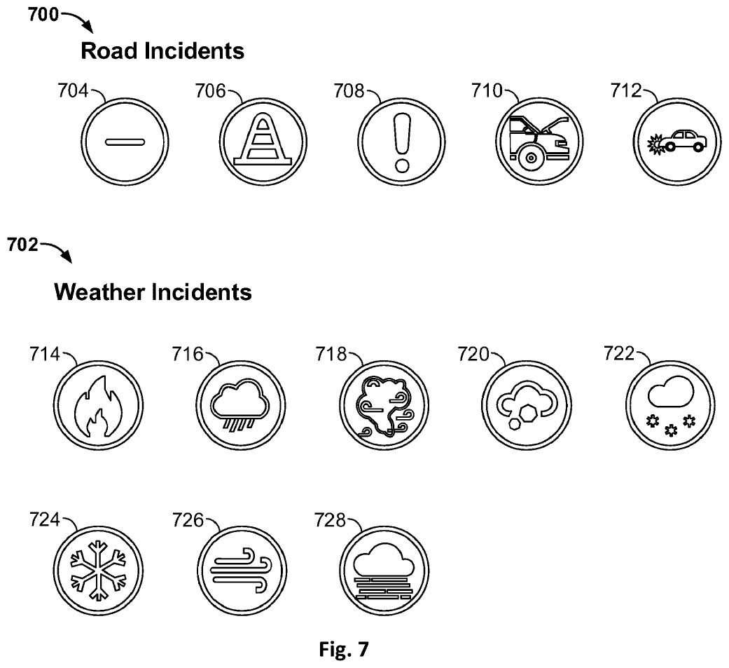

FIG. 7 shows illustrative depictions of icons for road and weather incident alerts 700, 702, in accordance with some embodiments of the present disclosure. In some implementations, these road and weather incident alert icons 700, 702 may be the incident alerts that are displayed to the driver. In some implementations, road hazard information (e.g., road hazard types and locations) is received by the processing circuitry 102 of vehicle 101 and the road incident and weather incident icons 700, 702 are used to illustrate the locations and types of road hazards. In some embodiments, road incident icons 700 may include road closures 704, construction 706, road hazards or lane restrictions 708, disabled vehicles 710, or car crashes 712, which may all have a geographical location, area, or length of road that the road incident is associated with. In some embodiments, weather incident icons 702 may include fires 714, rainstorms 716, dust storms 718, hail 720, snow or ice storms 722, ice road patches 724, wind 726, and fog 728, which may all have a geographical area and time associated with the weather road hazard. It will be understood that the depictions of icons for road and weather incident alerts 700, 702 of FIG. 7 are merely illustrative of some of the incident alerts that can be presented to the driver and that various modifications can be implemented in accordance with the present disclosure.

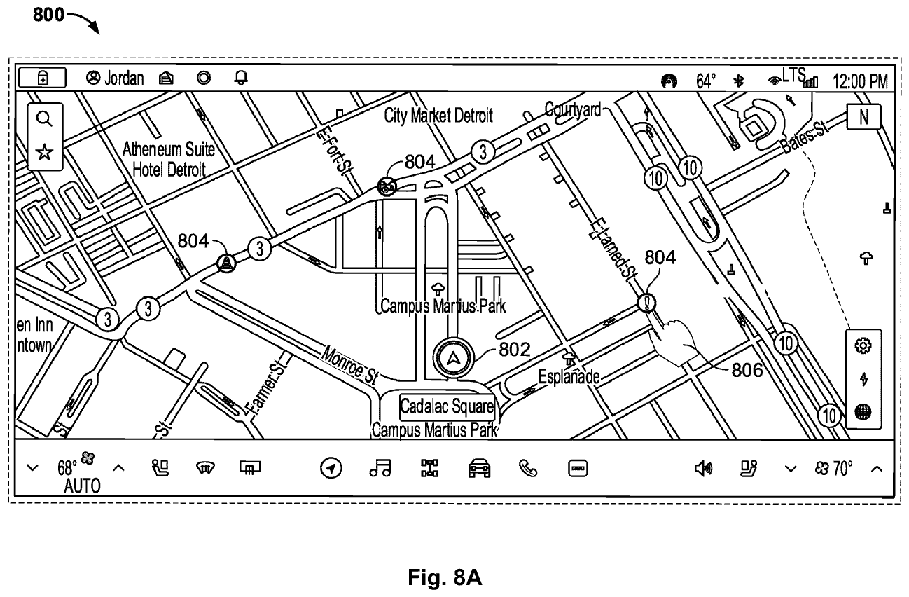

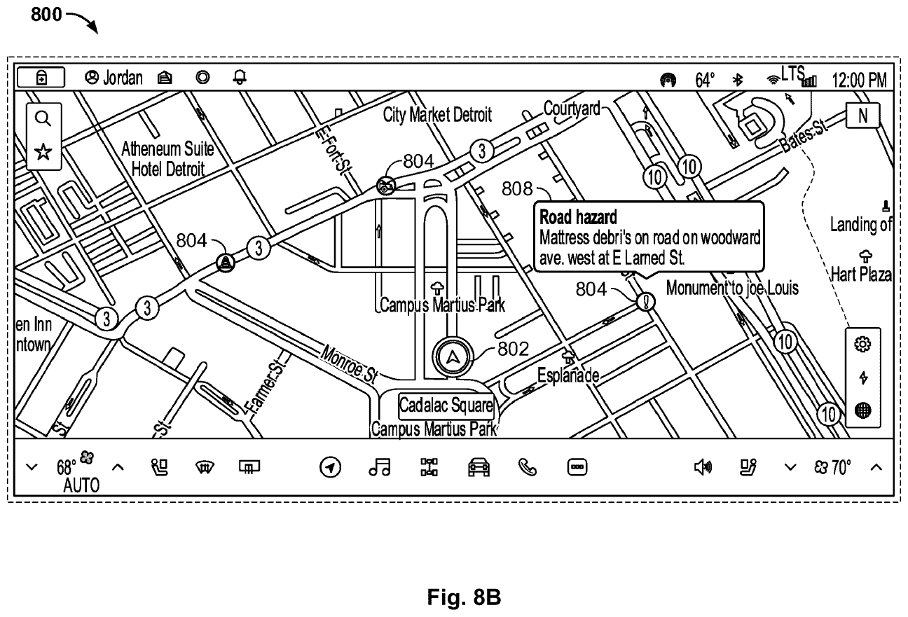

FIG. 8A shows an illustrative navigation interface 800 with a current location of vehicle 101, shown by indicator 802 in free drive navigation and multiple incident alert icons 804 that are selectable by user input 806, in accordance with some embodiments of the present disclosure. In some embodiments, free drive navigation refers to driving with a navigation interface, without any active guided route aiding the driver. In some implementations, the incident alerts 804 are displayed in navigation interface 800 with each incident alert depicted by one of the incident alert icons 700, and the location associated with the geographical location of the road hazard. In some embodiments, each of the incident alerts 804 are selectable by user input 806, by way of a touch screen, mouse, or dial user selection. The navigation interface 800 may be displayed to the driver on a display, such as one or more of the driver display 202 and/or the center display 206 in FIG. 2. In some embodiments, the processing circuitry 102 of the incident alert system determines a total risk score for each road hazard as a weighted summation of a set of risk factors from the risk factor information. Each total risk score can be used by the processing circuitry 102 to determine whether the corresponding road hazard is to be presented to the driver of the vehicle 101 as an incident alert. In some embodiments, each of the incident alerts 804 are presented to the driver of the vehicle indicator 802 due to the proximity of the road hazards to the vehicle indicator 802 while free driving to provide the driver with road hazard information on potential routes.

FIG. 8B shows the navigation interface 800 of FIG. 8A, where one of the alert icons 804 has been selected and corresponding road hazard information 808 is displayed, in accordance with some embodiments of the present disclosure. In some embodiments, when one of the incident alerts 804 is selected, the corresponding road hazard information 808 of the selected incident alert is displayed to the driver. The navigation interface 800 with road hazard information 808 may be displayed to the driver on a display, such as one or more of the driver display 202 and/or the center display 206 in FIG. 2. In some embodiments, the road hazard information 808 may include the type of incident alert, an address, or geographical location of the hazard, as well as a brief description of the incident alert 804.

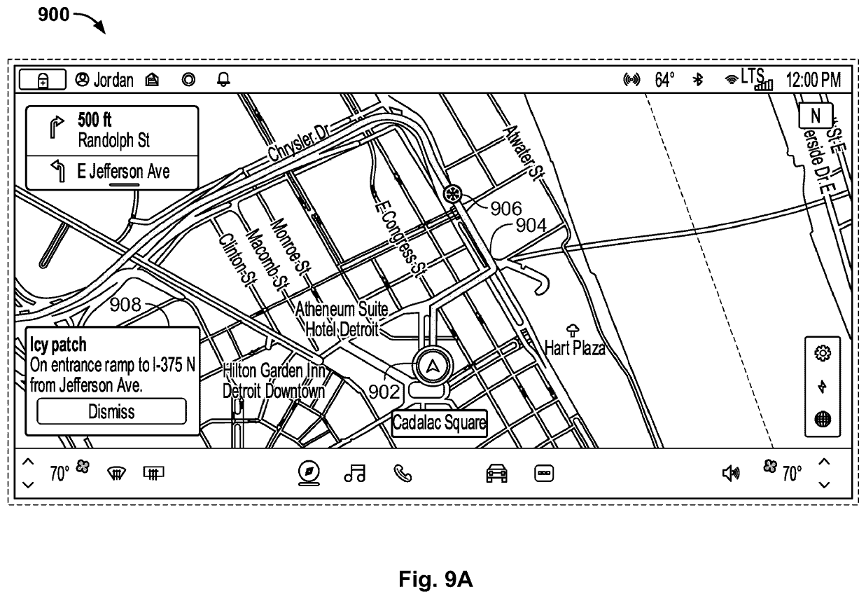

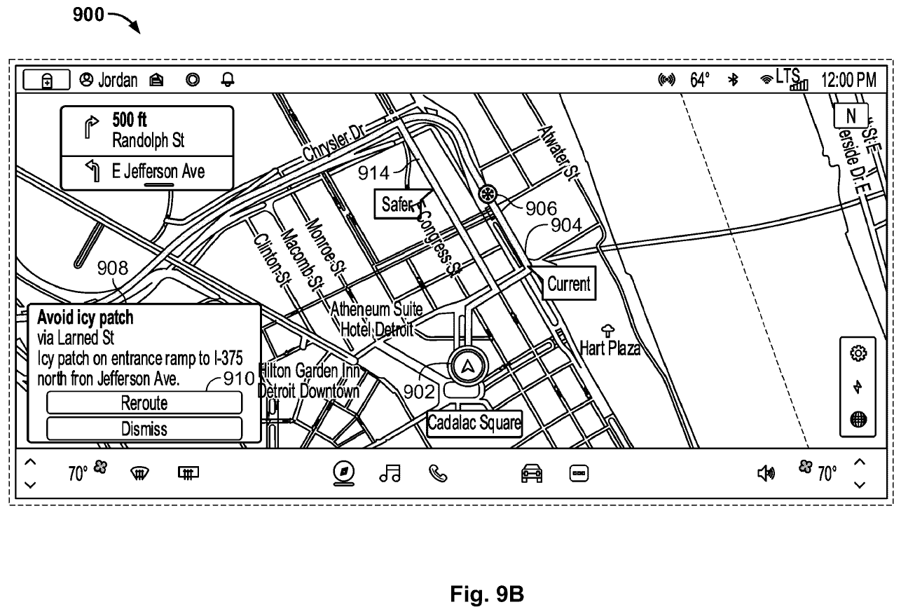

FIG. 9A shows an illustrative navigation interface 900 with a current location of a vehicle 101, shown by indicator 902 on a guided route 904, and an incident alert icon 906 on the route 904, in accordance with some embodiments of the present disclosure. For example, the vehicle 101 may receive road hazard weather information (e.g., icy road patch) based on the location of the vehicle, shown by indicator 902. In some embodiments, there are risk factors that affect the ability of the vehicle 101 to avoid the road hazard. It will be understood that avoiding a road hazard includes safely traversing the road hazard. For example, a vehicle that has sufficient tires can safely travel over the icy patch and thus avoid the road hazard. However, if vehicle 101 has bald tires and thus limited traction, the processing circuitry 102 may determine that the icy road patch road hazard should be presented to the driver as an incident alert icon 906. In some embodiments, tire wear is an example of risk factor information (e.g., vehicle status information 152). In another example, where the tires are new, winterized tires (e.g., vehicle status information 152 received via the vehicle's service record), the processing circuitry may determine that the road hazard should not be presented to the driver because the road hazard is low risk. When the processing circuitry 102 determines that the incident alert should be presented, the illustrative navigation interface 900 displays the weather incident alert icon 906 on the guided route 904. In some embodiments, the driver will receive alert 908 on the navigation interface 900 based on the corresponding road hazard information and the guided route 904 of the vehicle 101. The navigation interface 900 with alert details 908 may be displayed to the driver on a display, such as one or more of the driver display 202 and/or the center display 206 in FIG. 2. In some embodiments, there may be different levels of incident alerts for guided route navigation depending on the amount of risk (e.g., based on a total risk score) involved with the road hazard and risk factors. In some embodiments, a first level incident alert is presented as alert icon 906. A first level incident alert may occur when the processing circuitry 102 determines a total risk score corresponds to a low-level risk to the driver of vehicle 101. For example, the risk factor information may all indicate a low level risk associated with the road hazard so only alert icon 906 is displayed. However, if there are compounding factors (e.g., bald tires or high road gradient), a second or third level incident alert can be presented as described in connection with FIG. 9B.

FIG. 9B shows the navigation interface 900 of FIG. 9A, where an alternate route 914 is displayed that avoids the road hazard along with driver options 910 to accept or dismiss the alternate route 914, in accordance with some embodiments of the present disclosure. In some embodiments, the driver of the vehicle 101 receives an alert 908 in response to selecting alert icon 906 or along with alert icon 906 as a second level incident alert. Alert 908 may include information such as the type of the incident alert icon 906, the road, address, or geographical location of the road hazard, and additional information about the road hazard. Alert 908 may provide the driver with additional information to assist the driver in avoiding or traversing the road hazard. When there is a third level incident alert, alert 908 may additionally include options 910 to reroute the vehicle 101 to avoid the road hazard or to dismiss.

The second level incident alert may occur when the processing circuitry 102 determines that there is medium level risk associated with the road hazard. For example, bald tires or the location of the icy patch being on a road incline may cause the risk level to increase from low to medium. As explained above, in a second level incident alert, the alert 908 may be displayed in addition to alert 906 to provide additional assistance to the driver. The third level incident alert may occur when the processing circuitry 102 determines that there is high level risk associated with the road hazard. For example, if the icy road patch is on a road incline and the vehicle has bald tires, this may cause the risk level to increase to a high level. In a third level incident alert, the processing circuitry 102 may determine to display incident alert icon 906, alert 908 including options 910, and alternate route 914. The third level incident enables the driver to easily avoid the road hazard by selecting the reroute option 910. The total risk score can thus be used to differentiate between different levels of risk so that an appropriate level of incident alert can be displayed. In some embodiments, the risk factors are combined using equal weights. In some embodiments, the risk factor weights are dynamically weighted based on the type of road hazard and the relative importance of the risk factor to the type of road hazard.

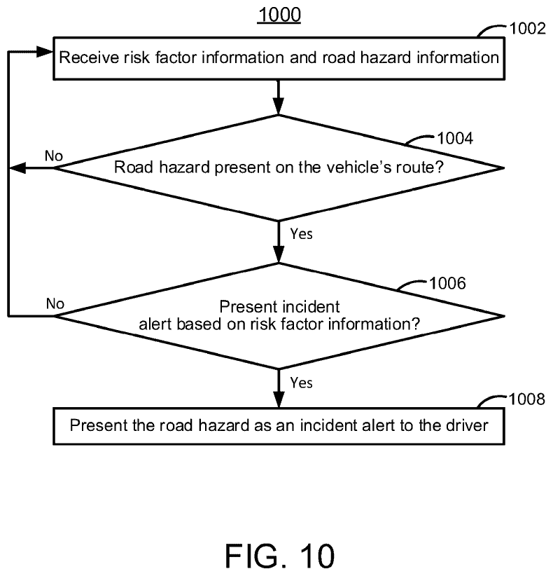

FIG. 10 shows a flowchart of an illustrative process 1000 for determining whether to present an incident alert to the driver based on risk factor information and road hazard information, in accordance with some embodiments of the present disclosure. In some embodiments, process 1000 is executed by processing circuitry 102 of the vehicle 101. In some embodiments, process 1000 is executed by processing circuitry 102 as part of an incident alert system in vehicle 101.

At 1002, processing circuitry 102 receives road hazard information 156 and risk factor information. In some embodiments, the road hazard information 156 and risk factor information may be received via the communications circuitry 142 that is communicatively reachable by server 146. In some embodiments, the risk factor information and road hazard information 156 is locally stored and received from memory 106. In some embodiments, the road hazard information 156 includes road incidents and weather incidents. The road incidents may include one or more of a road closure, construction, road hazard, lane restriction, disabled vehicle, or car crash. The weather incidents may include one or more of fire, rainstorms, dust storms, hail, snow or ice storms, ice road patches, wind, and fog. The risk factor information may include one or more of driver behavior information 150, vehicle state information 152, environmental conditions 154, or any other information that affects a vehicle's ability to avoid a road hazard. In some embodiments, the driver behavior information 150 may include one or more of driver experience, or driver distraction. In some embodiments, the vehicle state information 152 may include one or more of tire wear, brake wear, accelerator pedal depressed, vehicle lane, windshield clarity, or vehicle equipment. In some embodiments, environmental conditions 154 may include one or more of road geometry, traffic obstructions, road surface condition, weather, tailgating vehicle, or available escape route.

At 1004, the processing circuitry 102 determines whether a road hazard is present on the current route of the vehicle 101. The received road hazard information 156 may include location information about the road hazard. In some embodiments, the processing circuitry 102 determines whether the road hazard is present on the current route of the vehicle 101 by comparing the location of the road hazard to the current vehicle route. The current vehicle route may be based on free driving (e.g., without guided navigation) or guided route driving. For example, when guided route driving, the processing circuitry 102 of the vehicle 101 may determine if the road hazard is located along the guided route. In a free-driving example, the processing circuitry 102 may determine if the road hazard is ahead of the vehicle on the current road or on a road intersecting with the current road within a predetermined distance away from the current vehicle position or from where the roads intersect. For example, a car crash may be included within the road hazard information 156 received by the processing circuitry 102 of vehicle 101. The road hazard information 156 may indicate the geographical location or address of the car crash. Therefore, the processing circuitry 102 may determine whether the car crash is present on the current route of the vehicle, which may be determined by comparing the current route of the vehicle 101 to the location of the car crash. When the processing circuitry 102 determines that a road hazard is not present on the current route of the vehicle 101, the processing circuitry 102 will continue to receive road hazard information 156 and risk factor information at 1002. However, when processing circuitry 102 determines that a road hazard is present on the current route of the vehicle, the process 1000 proceeds to step 1006.

At 1006, the processing circuitry 102 determines whether an incident alert should be presented based on the risk factor information. In some embodiments, the processing circuitry 102 determines whether to present the incident alert by checking whether any of the risk factor information indicates an increased risk (e.g., low visibility, bald tires, incline/decline road gradient, curvy road, etc.). For example, if any risk factor indicates increased risk, the processing circuitry 102 may determine to present the incident alert. In some embodiments, the processing circuitry 102 may evaluate the risk factor information in combination in order to determine whether to present an incident alert. In some embodiments, the processing circuitry 102 determines that a road hazard is to be presented to the driver of the vehicle 101 when a total risk score (TRS) is greater than a threshold. The threshold may be a total risk score threshold that when met or exceeded, indicates that the road hazard may be presented to the driver of vehicle 101. In some embodiments, each type of road hazard may have a total risk score threshold, and the processing circuitry 102 determines the total risk score of a road hazard based on the relevant risk factor information. For example, the processing circuitry 102 may determine the total risk score as a weighted summation of a set of risk factors from the risk factor information. In some embodiments, for example, the weighted summation equation can be calculated using the following equation:

TRS=(Risk Factor₁)*(Weight₁)+(Risk Factor₂)*(Weight₂)+ . . . +(Risk Factorₙ)*(Weightₙ),

where the total risk score (TRS) is the weighted summation of n number of risk factors with n number of corresponding weights. In some embodiments, the risk factors are equally weighted. In some embodiments, the risk factors are dynamically weighted based on the importance of the risk factor and/or the type of road hazard. The weights may be determined and assigned by the processing circuitry 102 or retrieved by the use of a lookup table. The total risk score corresponds to a level of risk associated with a road hazard. When the processing circuitry 102 determines that the incident alert should not be presented to the driver (e.g., the total risk score is less than a threshold), the processing circuitry 102 continues to receive risk factor information and road hazard information 156 at 1002. However, when processing circuitry 102 determines that the incident alert should be presented to the driver (e.g., the total risk score is greater than a threshold), the process proceeds to 1008.

At 1008, the processing circuitry 102 presents the incident alert to the driver. In some embodiments, the processing circuitry 102 provides the driver with an incident alert on a display 140, speaker 138, or tactile element 136 via the incident alert interface 130 of the output circuitry 128. For example, the processing circuitry 102 may present incident alert icon 906 on navigation interface 900. In some embodiments, the processing circuitry 102 may additionally present one or more of alert 908, options 910, and alternate route 914. In some embodiments, the type or number of incident alerts presented (e.g., a first level incident alert, a second level incident alert, etc.) depends on the level of risk associated with the road hazard.

It will be understood that process 1000 of FIG. 10 is merely illustrative and that various modifications can be implemented in accordance with the present disclosure. In some embodiments, the processing circuitry 102 may additionally or alternatively determine when to present an incident alert based on risk factor information, type of road hazard, and location of the road hazard. For example, the incident alert may be presented to the driver at a later time when the risk factor information indicates low risk. When there is low risk, the incident alert may be presented when the vehicle is a first distance away from the road hazard. When there is medium risk, the incident alert may be presented when the vehicle is a second greater distance away from the road hazard. As the risk increases, the incident alert can be presented sooner to provide earlier notification to the driver. In some embodiments, processing circuitry 102 additionally determines when to present the incident alert at 1006. As an example, there may be a road hazard in the rightmost lane of a three-lane road. In this example, if there is a vehicle in the leftmost lane and a vehicle in the middle lane, the lane position affects the risk of the road hazard. That is, the vehicle in the leftmost lane has lower risk than the vehicle in the middle lane to the road hazard. Therefore, the incident alert can be presented to the vehicle in the middle lane sooner than the vehicle in the leftmost lane.

The timing of when the incident alert is presented can be determined using a threshold. The threshold may be represented as a distance or time from a road hazard before presenting an incident alert to the driver. In some embodiments, the threshold for presenting incident alerts may be adjusted similarly to adjusting the threshold for ADAS features as discussed above in connection with FIG. 4. Similar to 402, road hazard information 156 and risk factor information are received by the processing circuitry 102. Similar to 404, the threshold for presenting an incident alert is adjusted based on risk factor information, such as driver behavior information 150, vehicle state information 152, environmental conditions 154 and other information that may affect the vehicle's ability to avoid the road hazard associated with the incident alert. In some embodiments, when the processing circuitry 102 determines that the risk factor information indicates a high level of risk, the threshold can be adjusted to be larger such that the incident alert is presented earlier. In some embodiments, adjusting the threshold for presenting the incident alert includes inputting a risk factor value into an equation or a lookup table to obtain the adjusted threshold. Similar to 406, the processing circuitry 102 determines whether to present the incident alert based on the adjusted threshold being met, such as a timing threshold or distance threshold away from the road hazard before presenting the incident alert to the driver of vehicle 101.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A system, comprising:
input circuitry configured to receive:
risk factor information that affects a vehicle's ability to react to a surrounding environment at a vehicle speed; and
sensor data; and
processing circuitry configured to:
adjust a threshold based on the risk factor information, wherein the threshold affects timing of an advanced driver assistance system (ADAS) feature; and
determine whether to perform the ADAS feature based on the adjusted threshold and the sensor data.

2. The system of claim 1, wherein the ADAS feature comprises one of:
a forward collision warning (FCW) feature;
a blind spot warning (BSW) feature;
an adaptive cruise control (ACC) feature; or
an automatic emergency braking (AEB) feature.

3. The system of claim 1, wherein when the risk factor information indicates a first risk level, the processing circuitry is configured to adjust the threshold so that the timing of the ADAS feature occurs at a first time and wherein when the risk factor information indicates a second higher risk level, the processing circuitry is configured to adjust the threshold so that the timing of the ADAS feature occurs at a second earlier time.

4. The system of claim 1, wherein the risk factor information comprises a first risk factor and a second risk factor, wherein the processing circuitry is further configured to determine a total risk score as a weighted summation of the first risk factor and the second risk factor, and wherein the processing circuitry is configured to adjust the threshold based on the risk factor information by adjusting the threshold based on the total risk score.

5. The system of claim 1, further comprising output circuitry that is configured to, in response to determining to perform the ADAS feature, send a signal to perform the ADAS feature.

6. The system of claim 1, wherein the ADAS feature comprises a visual notification and wherein the system further comprises a user interface configured to display the visual notification.

7. The system of claim 1, wherein the ADAS feature comprises automatic emergency braking and wherein the system comprises an automatic brake system configured to, in response to determining to perform the ADAS feature, perform automatic braking of the vehicle.

8. The system of claim 1, wherein the risk factor information comprises environmental conditions comprising one or more of road geometry, traffic obstructions, road surface condition, weather, tailgating vehicle, or available escape route.

9. The system of claim 1, wherein the risk factor information comprises driver behavior information comprising one or more of history of ADAS warnings, average braking reaction time, steering wheel adjustments, driver experience, or driver distraction.

10. The system of claim 1, wherein the risk factor information comprises vehicle state information comprising one or more of tire wear, brake wear, accelerator pedal position, vehicle lane, windshield clarity, or vehicle equipment.

11. The system of claim 1, wherein the sensor data is received from one or more of a camera, radar sensor, angle sensor, accelerometer, or a global positioning system.

12. A method for driver assistance on a vehicle, the method comprising:
receiving risk factor information that affects a vehicle's ability to react to a surrounding environment at a vehicle speed and sensor data;
adjusting, using processing circuitry, a threshold based on the risk factor information, wherein the threshold affects timing of an advanced driver assistance system (ADAS) feature; and
determining, using the processing circuitry, whether to perform the ADAS feature based on the adjusted threshold and the sensor data.

13. The method of claim 12, wherein the ADAS feature comprises one of:
a forward collision warning (FCW) feature;
a blind spot warning (BSW) feature;
an adaptive cruise control (ACC) feature; or
an automatic emergency braking (AEB) feature.

14. The method of claim 12, wherein when the risk factor information indicates a first risk level, the threshold is adjusted so that the timing of the ADAS feature occurs at a first time and wherein when the risk factor information indicates a second higher risk level, the threshold is adjusted so that the timing of the ADAS feature occurs at a second earlier time.

15. The method of claim 12, wherein the risk factor information comprises a first risk factor and a second risk factor, the method further comprising:
determining a total risk score as a weighted summation of the first risk factor and the second risk factor, wherein adjusting the threshold based on the risk factor information comprises adjusting the threshold based on the total risk score.

16. The method of claim 12, wherein the ADAS feature comprises a visual notification, the method further comprising presenting the visual notification on a user interface.

17. The method of claim 12, wherein the risk factor information comprises environmental conditions comprising one or more of road geometry, traffic obstructions, road surface condition, weather, tailgating vehicle, or available escape routes.

18. The method of claim 12, wherein the risk factor information comprises driver behavior information comprising of one or more of history of ADAS warnings, average braking reaction time, steering wheel adjustments, driver experience, or driver distraction.

19. The method of claim 12, wherein the risk factor information comprises vehicle state information comprising one or more of tire wear, brake wear, accelerator pedal position, vehicle lane, windshield clarity, or vehicle equipment.

20. A non-transitory computer-readable medium having non-transitory computer-readable instructions encoded thereon that, when executed by processing circuitry, cause the processing circuitry to:
receive risk factor information that affects a vehicle's ability to react to a surrounding environment at a vehicle speed and sensor data;
adjust a threshold based on the risk factor information, wherein the threshold affects timing of an advanced driver assistance system (ADAS) feature; and
determine whether to perform the ADAS feature based on the adjusted threshold and the sensor data.
